(19) United States
(12) Patent Application Publication
(10) Pub. No.: US 2006/0223490 A1
(43) Pub. Date: Oct. 5, 2006

(54) System and method for providing deferred service

(75) Inventors: Joo-Young Kim, Suwon-si (KR); Wuk Kim, Gwacheon-si (KR); Sang-Kyung Sung, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/397,011

(22) Filed: Apr. 3, 2006

(30) Foreign Application Priority Data
Apr. 2, 2005 (KR) 2005-27837
Mar. 31, 2006 (KR) 2006-29756

(51) Int. Cl. H04Q 7/20

(52) U.S. Cl. 455/403

(57) ABSTRACT

Disclosed is a system for providing a deferred service, the system including a Secure User Plane Location (SUPL) agent for requesting the deferred service according to a requirement of a client; and a SUPL Location Platform (SLP) for checking for allowance or denial of an event report for an event when the event occurs during the deferred service according to the request. In the system, allowance or denial of a user for a deferred service is reflected during the deferred service, and as a result, it is possible to prevent the violation of a user's privacy.

### PRIORITY

This application claims priority to an application entitled “System And Method For Providing Deferred Service” filed in the Korean Intellectual Property Office on Apr. 2, 2005 and assigned Serial No. 2005-27837 and on Mar. 31, 2006 and assigned Serial No. 2006-29756, the contents of which are incorporated herein by reference.

### BACKGROUND OF THE INVENTION

1. Field of the Invention

The present invention relates to a location-based service system, and more particularly to a system and a method for providing a deferred service, which belongs to a location-based service.

2. Description of the Related Art

A “deferred service” is referred to as a triggered service, in which a location server tracks the location of a terminal intended for reception of a deferred service, i.e. a target terminal which is the entity to be located, during a specific duration, computes the location information of the target terminal according to specific conditions provided by a location service requester, and transfers the computed location information to the location service requester.

The specific conditions or criteria provided by the location service requester may include an available event of the target terminal, a change of area event, a period event, etc.

The available event represents a condition when the target terminal can evaluate an occurrence of an event corresponding to a deferred service, and may represent if the target terminal has been connected to a network. The change of area event represents the change of an event to be checked for the target terminal, and may include a change in an area including the target terminal, a state change including arriving at, staying in, or leaving a specific area of the target terminal, etc. The period event represents a time period with which the target terminal checks an event, and may include a time period such as an hour or three hours.

Conventionally, if a deferred service is requested by a location service requester, a location server transmits a notification message, which represents that the deferred service has been requested, to a target terminal, i.e. a terminal intended for reception of the deferred service, before starting the deferred service. The notification message includes the type of location request, the identity of LoCation Service (LCS) client, the identity of location service requester, information of privacy verification, etc. The type of location request represents information on what service has been requested. The identity of the LCS client represents information for identifying a client, which receives the deferred service request of the location service requester, and transmits the deferred service request to the location server instead of the location service requester. The identity of the LCS client may include a mobile communications provider. The identity of the location service requester represents information for identifying a deferred service requester, and the information of privacy verification represents information for evaluating whether to allow the deferred service.

When the notification message, which represents that a deferred service has been requested, is received from the location server, the target terminal informs a user of the target terminal of the deferred service request, receives an indication of allowance or denial for the deferred service request from the user, and transmits a notification return message to the location server. The notification return message indicates whether to provide the deferred service. Then, the location server determines whether to provide the deferred service based on the notification return message received from the target terminal.

If providing the deferred service has been allowed, the location server starts the deferred service for the target terminal and begins location measurement of the target terminal according to the specific conditions provided by the location service requester. The location measurement may be performed by evaluating an event according to the specific conditions (the available event of the target terminal, the change of area event, the period event) provided by the location service requester, and providing results of the evaluation of the location server.

Hereinafter, a method for providing a deferred service according to the prior art will be described in more detail. FIG. 1 illustrates the method for providing the deferred service according to the prior art, by showing a case in which a target terminal is in a non-roaming state and a network determines a deferred event.

Referring to FIG. 1, in step 202, a Secure User Plane Location (SUPL) agent 10 requests a SUPL Location Platform (SLP) 20 to provide a deferred service according to a deferred service request from a client. That is, the SUPL agent 10 transmits a Mobile Location Platform-Trigger Location Reporting Request message (MLPTLRR) to the SLP 20. The MLP TLRR includes parameters such as an msid, an lcs-client and a tlrr-event. When the MLP TLRR is received from the SUPL agent 10, the SLP 20 performs a subscriber privacy verification according to the information included in the MLP TLRR. Herein, the SLP 20 performs the subscriber privacy verification by means of an lcs-client id, which corresponds to requester-side client identification information.

In step 204, the SLP 20 transmits a SUPL initialization message (SUPL INIT) to a target terminal 30, which requests a deferred service. The SUPL INIT includes a session-id, an address of the SLP and a positioning method. As a result of the privacy verification in step 202, if notification or verification is necessary, the SUPL INIT includes the notification. Further, the SLP 20 may transmit the SUPL INIT to the terminal 30 by using a Wireless Application Protocol (WAP) or a Short Message Service (SMS).

When the SUPL INIT is received from the SLP 20, the terminal 30 checks for allowance or denial of the deferred service through the notification included in the SUPL INIT. If a user allows the deferred service request, the terminal 30 transmits a SUPL start message (SUPL START) to the SLP 20 in step 206. The SUPL START includes a session-id, SET capabilities, and a location identifier. The session-id represents session identification information; the SET capabilities represents deferred service capability information of a terminal, and the location identifier represents location identification information of a terminal.

When the SUPL START is received from the terminal 30, the SLP 20 transmits a SUPL trigger request message (SUPL TRIGGER REQUEST) to the terminal 30 in step 208. The SUPL TRIGGER REQUEST includes criteria of the deferred service. After receiving the SUPL TRIGGER REQUEST, the terminal 30 transmits a SUPL trigger response message (SUPL TRIGGER RESPONSE) to the SLP 20 in step 210.

In step 212, the SLP 20 determines whether to use an extension flow according to the deferred service capability of the SLP 20 and the deferred service capability of the terminal 30. Then, the SLP 20 transmits a SUPL response message (SUPL RESPONSE) including results of the determination to the terminal 30. When the SUPL RESPONSE is received from the SLP 20, the terminal 30 transmits a SUPL position initialization message (SUPL POS INIT) to the SLP 20 in step 214. Steps 212 and 214 may, or may not, also be selectively performed. As a result of receiving the SUPL TRIGGER RESPONSE from the terminal 30, if the deferred service request has been allowed by a user, the SLP 20 transmits a deferred service start message (Triggered Location Reporting Answer (TLRA)) to the SUPL agent 10 in step 216, thereby reporting the start of the deferred service.

Further, if the deferred service request has been allowed by a user, the terminal 30 transmits the SUPL START to the SLP 20 according to the criteria of the received deferred service in step 218. In this case, the deferred service starts.

When the deferred service starts, the SLP 20 and the terminal 30 perform terminal position computation in step 220. Herein, the SLP 20 and the terminal 30 transmit and receive various positioning procedure messages for the terminal position computation. The position information of the terminal 30 may be computed in an MS-assisted scheme or an MS-based scheme. As a result of the terminal position computation, the terminal 30 transmits a SUPL report message (SUPL REPORT) to the SLP 20 in step 222.

After receiving the SUPL REPORT from the terminal 30, the SLP 20 transmits a MLPTLRR to the SUPL agent 10 in step 224. In the case of a periodic trigger, the SLP 20 transmits the MLPTLRR including a first position computation value to the SUPL agent 10. In the case of an event trigger, the SLP 20 determines an occurrence of an event, and transmits the MLPTLRR to the SUPL agent 10 only when the event has occurred.

Steps 218, 220, 222 and 224 are repeated at regular intervals. When the last position of the terminal 30 is computed, the SLP 20 transmits a SUPL end message (SUPL END) to the terminal 30 in step 226, thereby reporting the end of the terminal position computation. After receiving the SUPL END, the terminal 30 releases all resources for the deferred service.

According to the conventional method for providing the deferred service, whether the terminal 30 allows the deferred service is checked only once before the deferred service starts.

When an allowance command for the deferred service request is received from the terminal 30, the allowed deferred service is reported multiple times (multiple reports) to a client during a validity time. That is, the allowed deferred service is continuously provided until a service expiration time. Therefore, in the prior art method, once the deferred service is allowed, the terminal 30 cannot request a user to allow or deny another service while the deferred service is being provided.

That is, according to the conventional method, after the deferred service is allowed initially, it is impossible to reflect the intentions of a user regarding whether to allow the deferred service while the deferred service is being provided. Therefore, the user's privacy might be violated.

### SUMMARY OF THE INVENTION

Accordingly, the present invention has been made to solve the above mentioned problems, and it is an object of the present invention to provide a system and a method for providing a deferred service, which can prevent the privacy of a user from being violated by reflecting the intentions of the user regarding whether to allow the deferred service while the deferred service is provided.

It is another object of the present invention to provide a system and a method for providing a deferred service, which reports a corresponding event according to whether a user allows the deferred service for the event when the event occurs while the deferred service is provided.

According to an aspect of the present invention, there is provided a system for providing a deferred service, the system including a Secure User Plane Location (SUPL) agent for requesting the deferred service according to a requirement of a client; and a SUPL Location Platform (SLP) for checking for allowance or denial of an event report for an event when the event occurs during the deferred service according to the request.

According to another aspect of the present invention, there is provided a method for providing a deferred service, the method including performing the deferred service according to a deferred service request from a client; when an event occurs during the deferred service, receiving allowance or denial for an event report, which regards whether to report the occurred event to the client, from a user; and performing the event report according to the allowance or denial for the event report.

In accordance with further another aspect of the present invention, there is provided a system for providing a deferred service, the system comprising: a Secure User Plane Location (SUPL) agent for requesting the deferred service according to a requirement of a client; a SUPL Location Platform (SLP) for performing the deferred service according to the deferred service request; and a terminal for determining an occurrence of an event during the deferred service, and checking allowance or non-allowance of an event report for the event when it is determined that the event has occurred.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a method for providing a deferred service according to the prior art;

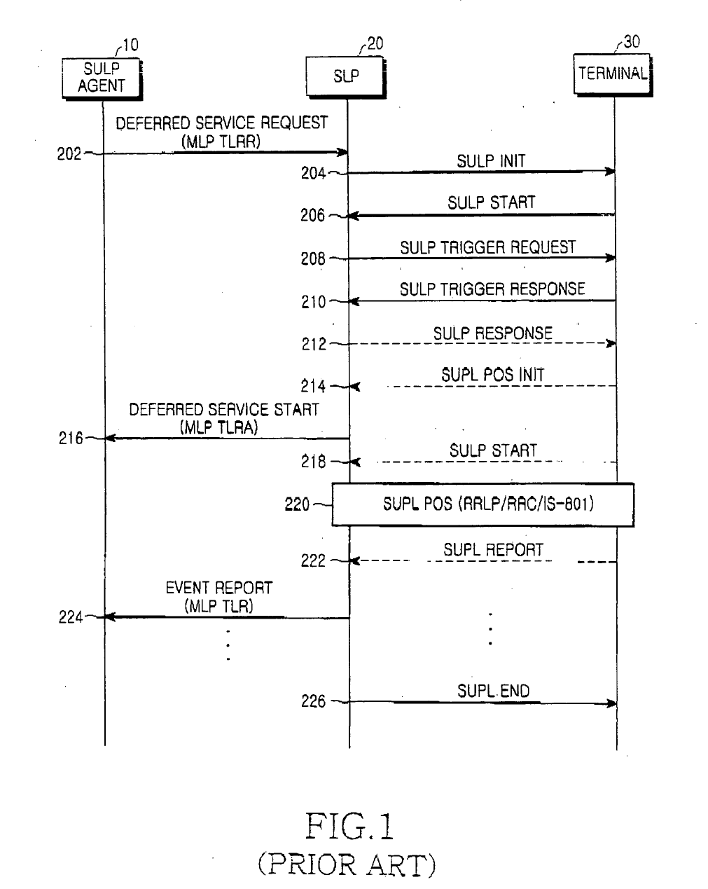

FIG. 2 is a block diagram illustrating the construction of a system for providing a deferred service according to the present invention;

FIG. 3 illustrates a method for providing a deferred service according to the present invention;

FIG. 4 illustrates a SUPL CONFIRM REQUEST according to the present invention; and

FIG. 5 illustrates a SUPL CONFIRM RESPONSE according to the present invention.

### DETAILED DESCRIPTION OF THE PREFERRED EMBODIMENT

A preferred embodiment of the present invention will be described in detail herein below with reference to the accompanying drawings. In the following description, a detailed description of known functions and configurations incorporated herein will be omitted for clarity and conciseness.

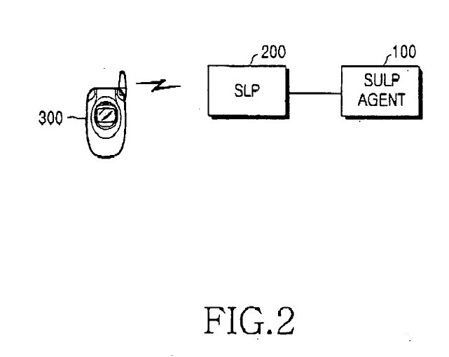

FIG. 2 is a block diagram illustrating the construction of a system for providing a deferred service according to the present invention.

Referring to FIG. 2, the system for providing the deferred service according to the present invention includes a Secure User Plane Location (SUPL) agent 100, a SUPL Location Platform (SLP) 200, and a terminal 300. Terminal 300 corresponds to a terminal capable of using a SUPL service.

The SUPL agent 100 receives a deferred service request for the terminal 300 from a client, generates a MLP TLRR, and transfers the MLP TLRR to the SLP 200. Herein, the SUPL agent 100 corresponds to a module included in all network apparatuses, which can provide a SUPL service, and a MLP message generator for the SUPL service.

When the deferred service request message is received from the SUPL agent 100, the SLP 200 performs a deferred service according to the position of the terminal 300, and transfers performance results of the deferred service to the SUPL agent 100. After receiving the deferred service request message, the SLP 200 searches for privacy profiles, which were previously stored by a user of the target terminal 300 intended for reception of the deferred service, based on the msid of the corresponding terminal 300, and checks the service request authority of the SUPL agent 100. If the deferred service is allowed by a user, the SLP 200 determines an occurrence of an event for the requested deferred service. Further, before the SLP 200 reports the occurrence of the event for the requested deferred service to the SUPL agent 100, the SLP 200 receives allowance or denial of an event report from the terminal 300. When the event report has been allowed by the terminal 300, the SLP 200 reports the occurrence of the event to the SUPL agent 100.

When the deferred service request is received from the SLP 200, the terminal 300 receives allowance or denial for the requested deferred service from a user, and transfers the allowance or denial for the requested deferred service to the SLP 200. If the deferred service is allowed by the user, the terminal 300 transmits/receives various positioning procedure messages for terminal position computation. Herein, the terminal 300 may compute its own position by means of an MS-assisted scheme or an MS-based scheme. Further, if the terminal 300 receives a verification request for allowance or denial of the event report from the SLP 200 during the deferred service, the terminal 300 verifies if the user has allowed the event report and transfers the verification results to the SLP 200.

That is, in the system for providing the deferred service according to the present invention as described above, the SLP 200 receives allowance or denial of the event report from the terminal 300 before reporting the occurrence of the event for the deferred service to a requester. If the event report has been allowed, the SLP 200 reports the occurrence of the event to the requester.

According to the system for providing the deferred service according to the present invention, it is possible to prevent an occurrence of an event relating to the position of a user from being reported to the third party without the user's allowance.

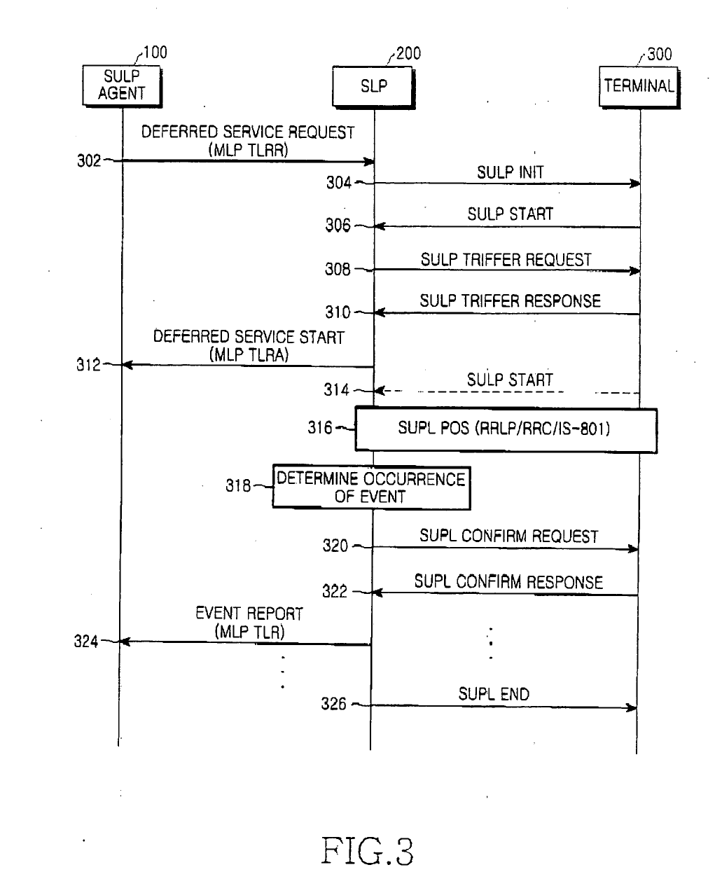

Hereinafter, a method by which the system provides the deferred service according to the present invention will be described. FIG. 3 is illustrates the method for providing the deferred service according to the present invention.

Referring to FIG. 3, in step 302, the SUPL agent 100 generates a MLP TLRR after receiving a deferred service request from a client, and transfers the MLP TLRR to the SLP 200. The MLP TLRR includes parameters such as an msid, an lcs-client and a tlrr-event. The msid corresponds to identification information for identifying a target terminal intended for reception of the deferred service, the lcs-client corresponds to a client of a deferred service request-side, and the tlrr-event corresponds to information on a deferred service request. When the MLP TLRR is received from the SUPL agent 100, the SLP 200 performs a subscriber privacy verification according to the information included in the MLP TLRR. Herein, the SLP 200 performs the subscriber privacy verification by means of an lcs-client id, which corresponds to requester-side client identification information.

In step 304, the SLP 200 transmits a SUPL initialization message (SUPL INIT) to a target terminal 300 intended for reception of the deferred service. The SUPL INIT includes session identification information (session-id), an address of the SLP 200 (address of the SLP) and a positioning method. As a result of the subscriber privacy verification in step 302, if notification or verification is necessary, the SUPL INIT includes the notification. Further, the SLP 200 may transmit the SUPL INIT to the terminal 300 by using a Wireless Application Protocol (WAP) or a Short Message Service (SMS).

When the SUPL INIT is received from the SLP 200, the terminal 300 checks for allowance or denial of the deferred service through the notification included in the SUPL INIT. If a user allows the deferred service request, the terminal 300 transmits a SUPL start message (SUPL START) to the SLP 200 in step 306. The SUPL START includes session identification information (session-id), SET capabilities, and location identification information (location identifier).

When the SUPL START is received from the terminal 300, the SLP 200 transmits a SUPL trigger request message (SUPL TRIGGER REQUEST) to the terminal 300 in step 308. The SUPL TRIGGER REQUEST includes criteria of the deferred service. After receiving the SUPL TRIGGER REQUEST, the terminal 300 transmits a SUPL trigger response message (SUPL TRIGGER RESPONSE) to the SLP 200 in step 310.

Then, the SLP 200 transmits a SUPL response message (SUPL RESPONSE) to the terminal 300 according to the criteria of the deferred service. Herein, the SLP 200 determines whether to use an extension flow according to deferred service capability of the SLP 200 and deferred service capability of the terminal 300, and may transmit the SUPL RESPONSE including results of the determination to the terminal 30. When the SUPL RESPONSE is received from the SLP 200, the terminal 300 transmits a SUPL position initialization message (SUPL POS INIT) to the SLP 200. The SUPL RESPONSE transmission step and the SUPL POS INIT transmission step may, or may not, also be selectively performed.

When the SUPL RESPONSE transmission step and the SUPL POS INIT transmission step are performed, if the SUPL RESPONSE is received, step 312 is performed. However, when the SUPL RESPONSE transmission step and the SUPL POS INIT transmission step are not performed, step 312 is performed after the SLP 200 receives the SUPL TRIGGER RESPONSE. As a result of receiving the SUPL TRIGGER RESPONSE from the terminal 300, if the deferred service request has been allowed by a user, the SLP 20 transmits a Mobile Location Platform Triggered Location Reporting Answer (MLP TLRA) to the SUPL agent 100 in step 312, thereby reporting the start of the deferred service.

Further, if the deferred service request has been allowed by a user, the terminal 300 transmits the SUPL START to the SLP 200 according to the criteria of the deferred service in step 314. In this case, the deferred service starts.

When the deferred service starts, the SLP 200 and the terminal 300 perform terminal position computation in step 316. Herein, the SLP 200 and the terminal 300 transmit and receive various positioning procedure messages for the terminal position computation. The position information of the terminal 300 may be computed in an MS-assisted scheme or an MS-based scheme. When the position information of the terminal 300 is computed in an MS-based scheme, the terminal 300 transmits a SUPL report message (SUPL REPORT) for its own position information to the SLP 200.

The SLP 200 determines an occurrence of an event according to the results of the terminal position computation in step 318. That is, the SLP 200 determines if there occurs an event corresponding to the criteria of the requested deferred service.

If an event occurs, the SLP 200 transmits an event report confirmation request message SUPL CONFIRM REQUEST to the terminal 300 in step 320 before reporting the occurrence of the event to the SUPL agent 100. Herein, the SUPL CONFIRM REQUEST represents a message for requesting user allowance regarding whether to report the occurred event to the SUPL agent 100.

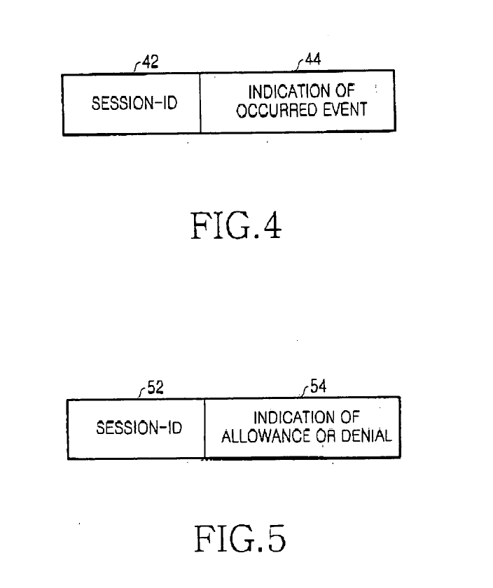

FIG. 4 illustrates the SUPL CONFIRM REQUEST according to the present invention. Referring to FIG. 4, the SUPL CONFIRM REQUEST includes a SESSION-ID 42 and IDENTIFICATION OF OCCURRED EVENT 44. The SESSION-ID 42 represents session identification information on an event report confirmation request, and the IDENTIFICATION OF OCCURRED EVENT 44 represents information on an occurred event. The IDENTIFICATION OF OCCURRED EVENT 44 may include information on a type of an event occurrence, e.g. information on whether a terminal has entered or left a specific area, etc.

In the meantime, as a result of verifying the privacy of the terminal 300, when a user has set an event occurrence report allowance process to be performed, the SLP 200 may also transmit the SUPL CONFIRM REQUEST or may also automatically transmit the SUPL CONFIRM REQUEST.

When the SUPL CONFIRM REQUEST is received from the SLP 200, the terminal 300 receives information on whether a report of the occurred event to a client is allowed by a user. Further, the terminal 300 transmits a report confirmation response message SUPL CONFIRM RESPONSE including an indication of allowance or denial of the event report by the user.

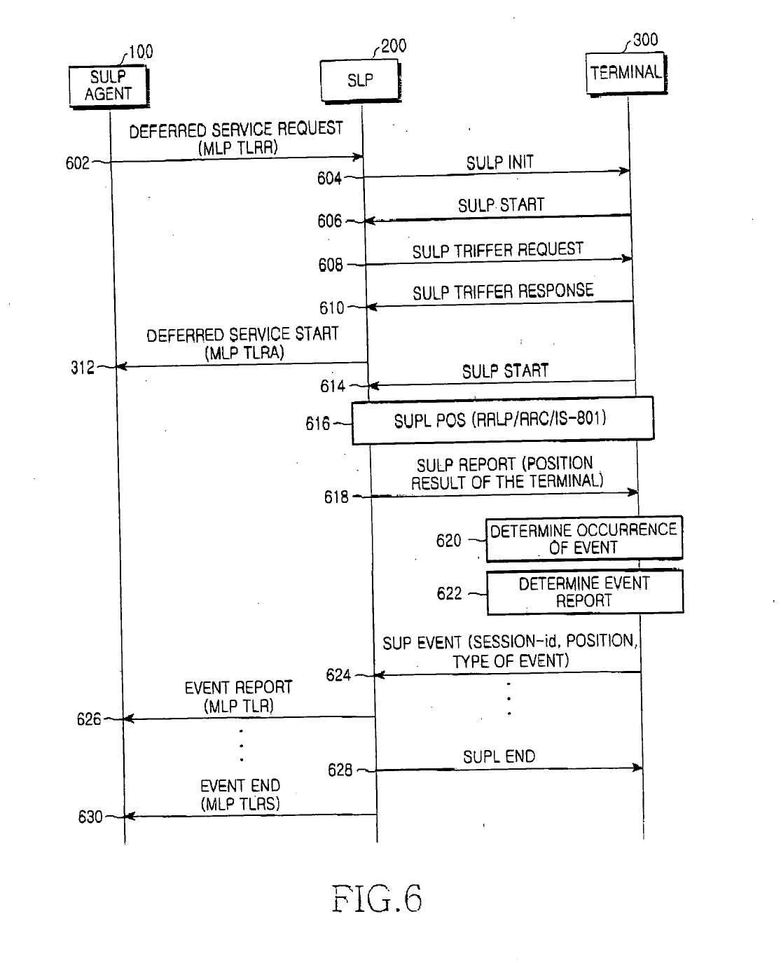

FIG. 5 illustrates the SUPL CONFIRM RESPONSE according to the present invention.

Referring to FIG. 5, the SUPL CONFIRM RESPONSE includes a SESSION-ID 52 and IDENTIFICATION OF ALLOWANCE OR DENIAL 54. The SESSION-ID 52 represents session identification information for reporting a response about an event report confirmation request, and the IDENTIFICATION OF ALLOWANCE OR DENIAL 54 represents information on whether a user allows or denies an event report. Herein, the terminal 300 may transmit the SUPL CONFIRM RESPONSE, which represents event report allowance by the user, to the SLP 200, or may also allow or deny an event report with no transmission of a response.

When the SUPL CONFIRM RESPONSE is received from the terminal 300, the SLP 200 determines whether to report the event occurrence according to allowance or denial of the event report included in the SUPL CONFIRM RESPONSE. As a result of receiving the SUPL CONFIRM RESPONSE from the terminal 300, if the event report has been denied by the user, the SLP 200 does not report the occurred event to the SUPL agent 100. However, if the event report has been allowed by the user, the SLP 200 reports the occurred event to the SUPL agent 100 in step 324.

Steps 314, 316, 318, 320, 322 and 324 may be repeated at regular intervals according to the criteria of the deferred service. When the last position of the terminal 300 is computed, the SLP 200 transmits a SULP end message SULP END to the terminal 300 in order to report the end of terminal position computation in step 326. After receiving the SUPL END, the terminal 30 releases all resources for the deferred service.

In FIG. 3, the SLP 200 determines the corresponding event occurrence by means of the position result (i.e. the computed position value) of the terminal 300, confirms whether to report the event occurrence through the terminal 300, and performs the event report operation to the SUPL agent 100 according to whether to report the event occurrence. Herein, the terminal 300 may also determine the corresponding event occurrence and whether to report the occurred event.

Hereinafter, a case in which the terminal 300 determines a corresponding event occurrence and whether to report the occurred event by means of its own position result (i.e. the computed position value of the terminal 300) will be described with reference to FIG. 6.

Steps 602, 604, 606, 608, 610, 612, 614 and 616 in FIG. 6 correspond to steps 302, 304, 306, 308, 310, 312, 314 and 316 in FIG. 3, respectively. Accordingly, a description about steps 602, 604, 606, 608, 610, 612, 614 and 616 will be omitted.

In an embodiment of FIG. 6, since the terminal 300 must determine the event occurrence, the terminal 300 must determine if its own position result satisfy an event occurrence condition. For example, making it a condition that an event has occurred when the terminal 300 is located in a specific area, the terminal 300 determines if its own position result corresponds to the specific area set as the condition.

For this, the terminal 300 must have its own computed position result after performing step 616. If the positioning method is a set-based-AGPS method, the terminal 300 computes the final position result. Accordingly, the terminal 300 has its own position result. However, if the positioning method is a set-assisted-AGPS method, the SLP 200 computes the final position result of a terminal. Accordingly, the SLP 200 must transfer the final computed position result to the terminal 300.

Accordingly, step 618 is performed when the SLP 200 has computed the final position result of the terminal in the terminal position computation of step 616, and the SLP 200 transfers the final computed position result to the terminal 300. The SUPL REPORT includes the final position result of the terminal. However, if the terminal 300 computes the final position result in the terminal position computation of step 616, step 618 is omitted because the terminal 300 has its own position result.

In step 620, the terminal 300 determines the event occurrence. That is, the terminal 300 determines if its own computed position result corresponds to the specific area set as the event occurrence condition.

When it is determined that an event has occurred because the computed position result corresponds to the specific area in step 620, step 622 is performed. That is, the terminal 300 determines whether to report the occurred event. Herein, the terminal 300 requests the terminal user to send a response regarding whether to report the occurred event, and then determines whether to report the occurred event according to the response of the terminal user. Further, the terminal 300 may request the response of the terminal user in various ways. For example, the terminal 300 displays a message requesting the response on the screen of the terminal 300, thereby requesting the response of the terminal user.

If a privacy profile exists in the terminal 300, the terminal 300 may also determine whether to report the occurred event according to the corresponding content of the privacy profile. Such a privacy profile represents a module or a memory of a terminal in which the terminal user has set conditions regarding an event report. For example, it is possible to set a report not to be performed even though an even occurred at a specific time zone, or when a value representing a specific position, which can include values around a specific position result designated by a user, coincides with a position result representing the current position of the user terminal.

Then, when the event report has been allowed in step 622, the terminal 300 transfers the corresponding event to the SLP 200 in step 624. Herein, the SUPL EVENT transferred from the terminal 300 to the SLP 200 in step 624 includes a session ID used for communication between the SLP 200 and the terminal 300, the position result of the terminal, and the type of the occurred event. However, when the event report has not been allowed in step 622, steps 624 and 626 are not performed.

After receiving the SUPL EVENT from the terminal 300 in step 624, the SLP 200 reports the event to the SUPL agent 100.

Steps 614, 616, 618, 620, 622, 624 and 626 may be repeated at regular intervals according to the deferred service condition. If the end time of the TRIGGERED LOCATIOIN SERVICE reaches, the SLP 200 transmits the SUPL END to the terminal 300 and reports the end in step 628. In step 630, the SLP 200 informs the SUPL agent 100 of the event end.

According to the present invention as described above, allowance or denial of a user for a deferred service is reflected during the deferred service, so that it is possible to prevent the privacy of a user from being violated.

That is, allowance or denial of a user for an event report is checked for before an event occurrence for the deferred service performed several times during a predetermined time period is reported to a requester, so that it is possible to prevent an occurrence of an event relating to the position of a user from being reported to the third party without the user's allowance.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A system for providing a deferred service, the system comprising:
a Secure User Plane Location (SUPL) agent for requesting the deferred service according to a requirement of a client; and
a SUPL Location Platform (SLP) for checking for allowance or denial of an event report for an event when the event occurs during the deferred service according to the request.

2. The system as claimed in claim 1, further comprising a terminal for checking for the allowance or denial of a user for the event report according to a check request for the allowance or denial of the event report from the SLP, and transmitting results of the checking for the allowance or denial of the event report to the SLP.

3. The system as claimed in claim 1, wherein the SLP determines whether to perform the event report according to the results of the checking for the allowance or denial of the event report.

4. The system as claimed in claim 2, wherein the SLP transmits an event report confirmation request message for checking for the allowance or denial of the user for the event report to the terminal.

5. The system as claimed in claim 4, wherein the event report confirmation request message includes both session identification information on an event report confirmation request and information on an occurred event.

6. The system as claimed in claim 4, wherein the terminal transmits a report confirmation response message for the allowance or denial of the user for the event report to the SLP.

7. The system as claimed in claim 6, wherein the report confirmation response message includes both session identification information for reporting a response for an event report confirmation request and information on the allowance or denial of the user for the event report.

8. A method for providing a deferred service, the method comprising the steps of:
performing the deferred service according to a deferred service request from a client;
when an event occurs during the deferred service, receiving an indication of allowance or denial for an event report, which regards whether to report the occurred event to the client, from a user; and
performing the event report according to the indication of allowance or denial for the event report.

9. The method as claimed in claim 8, wherein the step of receiving the indication of allowance or denial for the event report comprises:
determining if the event occurs during the deferred service;
when the event occurs, transmitting an event report confirmation request message for the occurred event to a target terminal intended for reception of the deferred service;
receiving an event report confirmation response message from the terminal, the event report confirmation response message including the indication of allowance or denial for the event report; and
receiving notification whether to report the event report to the client according to the event report confirmation response message.

10. The method as claimed in claim 8, wherein the step of performing the event report comprises:
when the event report has been allowed, reporting the event to the client; and
when the event report has not been allowed, ignoring the event.

11. The method as claimed in claim 9, wherein the event report confirmation request message includes both session identification information on an event report confirmation request and information on an occurred event.

12. The method as claimed in claim 9, wherein the event report confirmation response message includes both session identification information for reporting a response for an event report confirmation request and information on the allowance or denial of the user for the event report.

13. A system for providing a deferred service, the system comprising:
a Secure User Plane Location (SUPL) agent for requesting the deferred service according to a requirement of a client;
a SUPL Location Platform (SLP) for performing the deferred service according to the deferred service request; and
a terminal for determining an occurrence of an event during the deferred service, and checking allowance or non-allowance of an event report for the event when it is determined that the event has occurred.

14. The system as claimed in claim 13, wherein the SLP computes a final position result of the terminal during the deferred service, and transfers the final computed position result to the terminal.

15. The system as claimed in claim 13, wherein the terminal computes its own final position result during the deferred service.

16. The system as claimed in claim 14, wherein, in determining the occurrence of the event, the terminal determines if the final position result of the terminal corresponds to a specific position preset in order to determine the occurrence of the event, and determines that the event has occurred if the final position result of the terminal corresponds to the preset specific position.

17. The system as claimed in claim 16, wherein, when the event report has not been allowed, the terminal transfer an SUPL EVENT to the SLP, and the SLP reports the occurred event to the SUPL agent.

18. The system as claimed in claim 17, wherein the SUPL EVENT corresponds to a message, which includes at least one of a session ID used for communication between the SLP and the terminal, the position result of the terminal, and type of the occurred event.

19. The system as claimed in claim 15, wherein, in determining the occurrence of the event, the terminal determines if the final position result of the terminal corresponds to a specific position preset in order to determine the occurrence of the event, and determines that the event has occurred if the final position result of the terminal corresponds to the preset specific position.
